(19) United States
(12) Patent Application Publication
(10) Pub. No.: US 2006/0086379 A1
(43) Pub. Date: Apr. 27, 2006

(54) Flame treatment of washing machine parts

(75) Inventors: Christopher L. Flowers, Humboldt, TN (US); William Paul Rushing II, Medina, TN (US)

Correspondence Address: DIEDERIKS & WHITELAW, PLC, 12471 Dillingham Square, #301, Woodbridge, VA, 22192, US

(73) Assignee: Maytag Corporation

(21) Appl. No.: 10/972,656

(22) Filed: Oct. 26, 2004

(51) Int. Cl. B08B 9/20; B08B 3/00

(52) U.S. Cl. 134/34; 134/25.2; 134/56 D

(57) ABSTRACT

Plastic components exposed to a washing chamber of a washing machine are flame treated to improve the stain resistance of the plastic components. In accordance with the invention, a plastic component is exposed to flame treatment for a sufficient amount of time for a reaction to occur with the plastic component such that at least a surface layer of the plastic component is modified to enhance the resistance of the plastic component to staining. Plastic dishwasher components that may be treated by the flame treatment include a dishwasher tub, a door liner, spray arms, racks, silverware baskets, a pump housing and the like. Plastic washing tubs, agitators, baffles and the like of clothes washing machines could also be advantageously treated.

### BACKGROUND OF THE INVENTION

1. Field of the Invention

The present invention pertains to the art of washing machines, specifically dishwashers and clothes washing machines, and, more particularly, to plastic washing machine parts having improved resistance to stains and a method of treating the plastic parts to improve stain resistance.

2. Discussion of the Prior Art

Typically, interior walls of a dishwasher tub are formed of plastic, generally polypropylene. In addition, the use of plastic for the internal components of dishwashers, such as spray arms, is becoming increasingly popular due to the relatively low cost, light weight, and flexibility of design offered by plastic. However, plastic dishwasher parts, as well as plastic food containers, are prone to staining by food residue. Plastic dishwasher parts are particularly prone to red stains from processed tomato products, such as tomato sauce, ketchup, and spaghetti sauce. Red stains, technically known as carotenoid stains, are caused by lycopene in tomato products. Lycopene is easily absorbed into plastic items and cannot be completely removed by dishwashing detergents.

Although reducing the ability of a part to be stained may be of interest in certain other fields, the problems associated with staining are of particular concern in connection with plastic dishwasher components. For instance, both a tub and door liner of a dishwasher are typically white in color. During use, if these components are discolored by tomato or other food product stains, the overall appearance of the dishwasher is degraded. Certainly, consumers do not want to put dishes to be cleaned in a dishwasher which has a soiled or otherwise stained washing chamber. As plates or bowls containing tomato or other high staining foods are oftentimes not rinsed prior to loading a dishwasher, the staining foods will tend to drip onto the inner components of the dishwasher. If these staining foods remain on the plastic components for any significant length of time prior to operating the dishwasher, a certain amount of staining is sure to occur.

Of course, many of the dishwasher parts could be made from materials which would inherently resist staining, such as stainless steel. However, although a market exists for such high-end products, the need to provide a more economically feasible dishwasher leads to the increasing need to employ plastic parts. Some similar problems also exist in connection with clothes washing machines, specifically those incorporating plastic washing tubs or spinners, agitators and/or baffles. Certainly, unsightly stains on these components will lead to customer dissatisfaction. Based on the above, there exists a need to make plastic washing machine parts that are more resistant to staining.

### SUMMARY OF THE INVENTION

The present invention is concerned with treating plastic components of a washing chamber with a flame in order to improve the stain resistance of the plastic components. In accordance with the invention, the plastic components are exposed to a flame for a sufficient amount of time for the flame to react with the plastic components, such that the flame modifies at least a surface layer of the plastic components.

It has been found that treating washing machine components in this manner significantly alters the resistance of the plastic components to staining, even staining associated with tomato based products which is of particular concern in the art of dishwashers. In connection with a preferred aspect of the invention, plastic dishwasher components that are treated by the flame treatment include: dishwasher tubs, door liners, spray arms, racks, conduits, silverware baskets, pump housings, and the like. For clothes washing machines, plastic tubs or spinners, agitators, baffles and the like are advantageously treated. That is, any plastic component which is arranged in a washing chamber so as to be subject to staining by foods or soiled clothes may be treated in accordance with the present invention.

Additional objects, features and advantages of the present invention will become more readily apparent from the following detailed description of preferred embodiments of the invention.

### BRIEF DESCRIPTION OF THE DRAWINGS

FIG. 1 is a view of a dishwasher containing plastic parts treated in accordance with the present invention; and

FIG. 2 is a side view of a plastic dishwasher part treated in accordance with the invention.

### DETAILED DESCRIPTION OF THE PREFERRED EMBODIMENTS

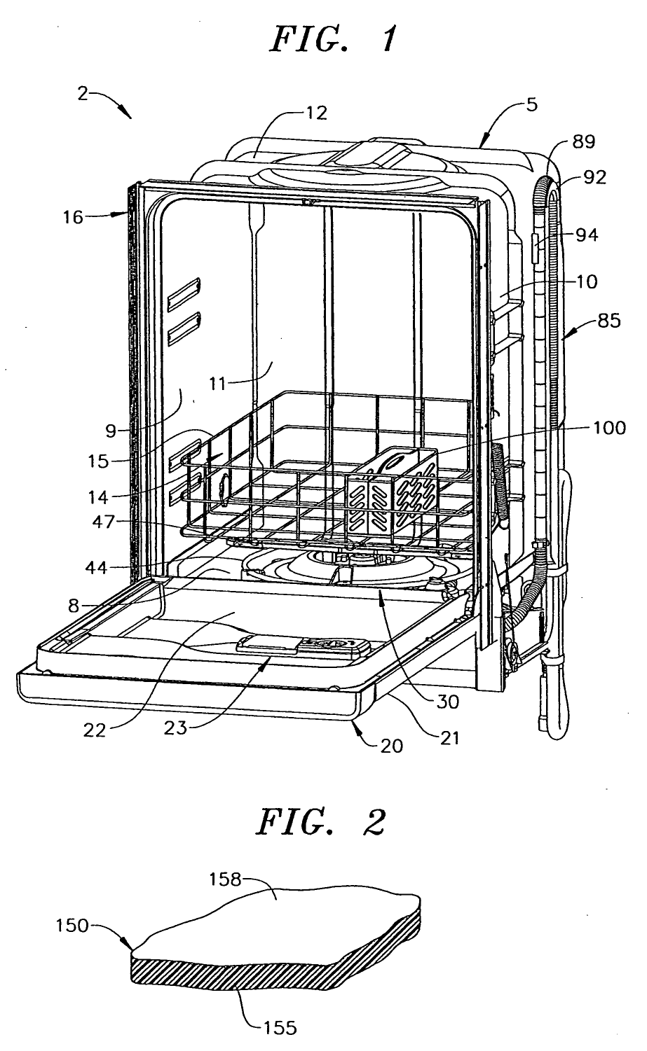

With initial reference to FIG. 1, the invention will be described with particular reference to a dishwasher 2. As shown, dishwasher 2 includes a tub 5 which is injection molded of plastic, preferably polypropylene, so as to include integral bottom, side, rear and top walls 8-12 respectively. Within the confines of walls 8-12, tub 5 defines a washing chamber 14 within which soiled kitchenware is adapted to be placed upon shiftable upper and lower racks (one of which is indicated at 15), with the kitchenware being cleaned during a washing operation in a manner widely known in the art. Tub 5 has attached thereto a frontal frame 16 which pivotally supports a door 20, having an outer panel 21 and an inner liner 22, used to seal chamber 14 during a washing operation. In connection with the washing operation, door 20 is preferably provided with a detergent tray assembly 23 within which a consumer can place liquid or particulate washing detergent for dispensing at predetermined cycles of the washing operation. Of course, dispensing detergent in this fashion is known in the art such that this arrangement is only being described for the sake of completeness.

Disposed within tub 5 and, more specifically, mounted within a central opening formed in bottom wall 8 of tub 5 is a pump and filter assembly 30. Extending about a substantial portion of pump and filter assembly 30, at a position raised above bottom wall 8, is a heating element 44. In a manner known in the art, heating element 44 preferably takes the form of a sheathed, electric resistance-type heating element. In general, pump and filter assembly 30 is adapted to direct washing fluid to a lower wash arm 47 and an upper wash arm (not shown). Dishwasher 2 has associated therewith a drain hose 85 including at least one corrugated or otherwise curved portion 89 that extends about an arcuate hanger 92 provided on an outside surface of side wall 10. Drain hose 85 is also preferably secured to tub 5 through various clips, such as that indicated at 94. In any event, in this manner, an upper loop is maintained in drain hose 85 to assure proper drainage in a manner known in the art. Actually, a detailed description of the exact structure and operation of pump and filter assembly 30 of dishwasher 2 does not form part of the present invention, but is rather set forth in pending U.S. application Ser. No. 10/186,739 entitled “Dishwasher Pump and Filtration System” filed Jul. 2, 2002, incorporated herein by reference. In addition, a silverware basket 100 is shown positioned in rack 15 in a manner known in the art.

The present invention is actually directed to providing various components of dishwasher 2 with an increased resistance to stains. In general, the process includes exposing plastic dishwasher parts to a flame treatment for an amount of time sufficient to allow the flame treatment to react with the plastic parts. It has been unexpectedly found that the reaction that takes place between the plastic parts and the flame treatment modifies the surface of the plastic parts such that the parts exhibit increased resistance to stains.

Essentially, any plastic dishwasher part that is susceptible to stains from contact with food residue may be treated by the process of the invention. The plastic dishwasher parts that may be treated include, but are not limited to, walls 8-12, a shiftable upper rack (not shown), shiftable lower rack 15, inner liner 22 of door 20, dispensing assembly 23, lower wash arm 47, an upper wash arm (not shown), at least the housing for pump and filter assembly 30, basket 100, and the like. However, for discussion purposes, reference will be made to FIG. 2 in discussing the treatment of a representative plastic dishwasher part which is generically referred to as plastic part 150. Preferably, plastic part 150 includes a main body 155 which is molded of polypropylene. Main body 155 has at least one surface 158 exposed to washing chamber 14.

The treatment in accordance with the invention includes exposing plastic part 150 to one or more flames, such as an assembly line system of gas burners or torches, placed in close proximity to surface 158 of plastic part 150. Since the distance between each flame and surface 158 of plastic part 150 affects the degree of surface modification, the visible blue portion of the flame is preferably kept no more than one inch from surface 158 of plastic part 150. The airflow of the burner is preferably in the order of 6 ounces per square inch and the burner speed is approximately 65 feet per minute. Plastic part 150 remains in contact with the flame for a sufficient amount of time for the flame to modify at least surface 158 of plastic part 150. However, the parameters may be adjusted in order to modify the results. For example, the dwell time of the flame treatment may be determined and adjusted according to the depth of plastic part 150 and the desired depth of treatment.

Surface 158 of plastic part 150, treated by the method of the invention, also exhibits improved surface energy or wettability, as well as enhanced drying characteristics as water tends to spread out on the components instead of beading into large droplets. Adjustments may be made to various parameters, such as burner speed and airflow, in order to achieve the equivalent of a plasma index of 45, which has been proven to be optimum for improving the wettability of plastic part 150.

As indicated above, plastic parts 150 that have undergone the flame treatment of the present invention have improved resistance to staining when compared to plastic parts that have not been treated. For example, a test was carried out to measure the difference in the stain resistance of plastic dishwasher parts that have been treated with the flame treatment of the invention versus parts not treated, wherein two dishwasher tubs were subjected to several wash cycles. Prior to the initial wash cycle, dishes soiled with tomato sauce and the like were placed within the washing chamber of each dishwasher. No cleaning or other modification of the dishwashers took place between cycles. One dishwasher included plastic parts which had been treated in accordance with the present invention and the other dishwasher included identical parts which were not treated. The change in color of the plastic parts was observed after each wash cycle and at the completion of all wash cycles. The plastic parts of the flame treated dishwasher unexpectingly showed little to no staining, i.e. substantially no change in lightness and color, while the untreated plastic parts contained seemingly irreversible staining.

The treated plastic dishwasher components have been found to not develop carotenoid stains caused by foods that contain lycopene. In any case, it should be readily apparent that treating plastic dishwasher components in accordance with the invention makes the components significantly more resistant to being stained from even the worst types of staining food substances typically experienced in connection with a domestic dishwasher. For a relatively minor incremental cost, various washing machine components can be treated to provide a long-lasting, more aesthetically appealing and overall hygienic washing chamber arrangement. Although described with reference to a preferred embodiment of the invention, it should be readily understood that various changes and/or modifications can be made to the invention without departing from the spirit thereof. For instance, although the invention is seen to have particular use in connection with treating dishwasher components, other washing machine components, such as clothes washing machine tubs or spinners, as well as agitators and baffles located in the tubs, can be made of plastic and benefit from the invention for generally corresponding reasons. Treating these washing machine components in a corresponding manner can prevent staining from various soils removed from clothing, as well as dyes which are inherently drawn from certain clothing during washing operations. In general, the invention is only intended to be limited by the scope of the following claims.

We claim:

1. A method for improving stain resistance of a plastic washing machine component arranged within a wash chamber of a washing machine comprising:
applying a flame treatment to the plastic washing machine component until the flame treatment modifies at least a surface layer of the plastic washing machine component to make the plastic washing machine component more resistant to staining.

2. The method according to claim 1, wherein the plastic washing machine component is molded of polypropylene.

3. The method according to claim 1, further comprising: utilizing the plastic washing machine component in forming a dishwasher.

4. The method according to claim 3, further comprising: employing a dishwasher tub as the plastic washing machine component.

5. The method according to claim 3, further comprising: employing a dishwasher door liner as the plastic washing machine component.

6. The method according to claim 3, further comprising: employing a dishwasher spray arm as the plastic washing machine component.

7. The method according to claim 1, further comprising: keeping a blue portion of a flame no more than one inch from the plastic washing machine component during flame treatment.

8. The method according to claim 1, further comprising: employing a burner in the flame treatment.

9. The method according to claim 8, further comprising: applying the flame treatment employing a burner speed of approximately 65 feet per minute.

10. The method according to claim 8, wherein the burner has an airflow of approximately 6 oz/in².

11. The method according to claim 10, further comprising: establishing the airflow and burner speed to achieve the equivalent of a plasma index of 45.

12. A washing machine with improved resistance to stains comprising:
a first washing machine component defined by a tub;
a second washing machine component defined by a door movable between an open position, wherein access to within the tub is permitted, and a closed position, wherein a washing chamber is established by the tub and door, at least one of the first and second washing machine components being formed from a plastic material and having a surface which is exposed to the washing chamber and has been flame treated such that the surface has been modified to enhance a resistance thereof to staining.

13. The washing machine according to claim 12, wherein the plastic material is polypropylene.

14. The washing machine according to claim 12, wherein the second washing machine component constitutes an inner liner of the door.

15. The washing machine according to claim 12, wherein the washing machine constitutes a dishwasher.
